(19) United States
(12) Patent Application Publication
(10) Pub. No.: US 2010/0128261 A1
(43) Pub. Date: May 27, 2010

(54) DEVICE FOR DETECTING AND CLASSIFYING RESIDUAL OXIDE IN METAL SHEET PRODUCTION LINES

(75) Inventors: Carlos Gonzalez Spinola, Los Barrios-Cadiz (ES); Francisco Garcia Vacas, Los Barrios-Cadiz (ES); Manuel Jesus Martin Vazquez, Los Barrios-Cadiz (ES); Julio Vizoso Laporte, Los Barrios-Cadiz (ES); Servando Espejo Meana, Los Barrios-Cadiz (ES); Juan Miguel Canero Nieto, Los Barrios-Cadiz (ES); Sergio Morillas Castillo, Los Barrios-Cadiz (ES); Domingo Guinea Diaz, Los Barrios-Cadiz (ES); Eugenio Villanueva Martinez, Los Barrios-Cadiz (ES); David Martin Gomez, Los Barrios-Cadiz (ES); José Maria D. Bonello Sánchez, Los Barrios-Cadiz (ES)

Correspondence Address: LUCAS & MERCANTI, LLP, 475 PARK AVENUE SOUTH, 15TH FLOOR, NEW YORK, NY, 10016, US

(73) Assignee: ACERINOX, S.A., Los Barrios-Cadiz (ES)

(21) Appl. No.: 12/593,981

(22) PCT Filed: Dec. 28, 2007
(86) PCT No.: PCT/ES07/00768

§ 371 Date: Jan. 21, 2010

(30) Foreign Application Priority Data
Apr. 2, 2007 (ES) P200700865

(51) Int. Cl. G01N 21/892; G01N 21/86

(52) U.S. Cl. 356/237.3

(57) ABSTRACT

Specially designed for the fully automated detection of residual oxide stains (residual scale) and classification thereof in metal sheet production lines, with no to stop the line, the invention consists of a framework or box (4) equipped with means for movement (8) over the surface of the metal sheet (2) to be examined, containing a high-resolution CCD camera (1), a high-power lighting unit (6-7) and a diffuse light generator; the video signal of the camera is sent to a PC (3) equipped with software for processing the images obtained, so that the residual oxide stains may be detected and classified. The movement of said box or framework (4) is controlled by a programmable automaton (14), also connected to said PC (3).

### OBJECT OF THE INVENTION

The present invention relates to an optical device specially designed for the fully automated detection of residual oxide stains (residual scale) and classification thereof in metal sheet production lines.

The object of the invention is to provide a device that allows the quality of these types of surfaces to be controlled by using an automatic optical system that moves over the material in order to detect and classify said oxide stains, which are difficult to see at first glance in the production line. Therefore, the invention falls within the sphere of the iron and steel industry and the manufacture of steels and metal materials with rough and highly reflective surfaces, and may be installed at the end of the surface stripping or cleaning process in order to carry out said surface inspection with no need to stop the line.

### BACKGROUND OF THE INVENTION

In the domain of practical application of the invention, the quality control of the metal sheet surfaces for the detection of small oxide stains on said surfaces, the operator normally uses a magnifying glass to thoroughly inspect the surface of every sheet, momentarily stopping the production line with the obvious ensuing problems and drawbacks.

This task, on being carried out by an operator, may not be as efficient as it should, as the highly reflective nature and roughness of the surface complicates inspection thereof due to the fact that the shine can hide the residual oxide or that the shade of the superficial granulation itself can be mistaken for oxide.

Due to the time required for this process, the quality of said surfaces is verified in a random manner, with scarce sampling, due to the fact that, as mentioned earlier, the production line must be stopped during inspection.

In the state of the art, U.S. Pat. No. 6,259,109 is known to use a camera to record and process a sheet moving along a production line. In this patent, the whole sheet must be recorded. The characteristics of the camera and installation thereof must be selected in such a manner as to encompass the width of the metal sheet, due to which formulas are indicated to calculate the field of view, lens zoom and working distance based on the aforementioned premise. These formulas are applied in order to detect defects on metal sheets 1 mm and 512 mm wide, also indicating the possibility of encompassing metal sheets up to 10 m wide and detecting defects from 25 microns, although both specifications simultaneously would entail the use of cameras that are not available in the current state of the art.

The present invention aims to detect residual oxide between 50 and 200 microns in size, the typical width being 1,500 mm and typical speed being 60m/min. Arranging a camera based on the idea of patent U.S. Pat. No. 6,259,109 involves a camera having a linear sensor of 60,000 pixels (1500/0.025), which is outside the range of commercial cameras. The typical length of one of the sheets is 1,000 metres, due to which storing the continuous sequence of the sheet would require around one Terabyte per sheet and hundreds of Terabytes per day. This patent does not seem to envisage real-time processing, due to which it would be impossible to obtain the necessary information about the type of residual oxide detected.

Likewise, the real-time processing power of the machine will be considerable, i.e. beyond the possibilities of a simple PC. To avoid these drawbacks and given the nature of the defect that we wish to detect, the present invention carries out a statistical analysis on the sheet. The video signal captured is digitised and processed in real time for classification thereof. Storage of all the images acquired is not required, only the real-time processing results for each zone of the sheet. Only a few images of each zone need be stored for monitoring purposes.

U.S. Pat. No. 6,259,109 cannot be used to detect residual oxides, as it does not discriminate between this defect and other similar ones. In this regard, it lacks all the real-time development of statistical image processing and adaptation to the process (oxide speed and size). Likewise, the present application is applied to stainless steel surfaces with inherent difficulties due to the shine of the material surface to be viewed and can detect pixels 10 microns in size, while the system of patent U.S. Pat. No. 6,129,109 can detect pixels of up to 25 microns in size, it being envisaged to fully record the band to be inspected using a linear camera, i.e. it does not move sideways but rather is synchronised using an encoder that indicates line speed, in such a manner that shooting speed is synchronised therewith.

Although this device perfectly fulfils the function for which it has been envisaged, it has a series of considerable limitations when the volume of sheets to be inspected is high, as the image processing and storage capacity required to install such a system would be economically unfeasible. In this regard, around 44 GB of storage space per day would be required and storage during one month would require 1.2 TB.

Devices with similar characteristics are disclosed in patent JP 63106265, which differs substantially from the present invention in that it is intended to store an image for representation on a screen where said defect has previously been detected, i.e. its purpose is not the detection of defects through image capturing, but rather enabling analysis thereof once captured.

As can be inferred from the abstract, Kansaki's system (JP 631106265) presupposes a prior detection of a defect on the sheet and that a signal is generated indicating the position along the width thereof that is connected to the system controller. Subsequently, the equipment positions a camera and obtains and stores images of the defective zone.

The system of this patent is limited to capturing images of the defect and storing these together with the position thereof in order to subsequently view the defect, without carrying out analyses of any kind.

In our system we carry out a real-time statistical analysis of the surface of the sheet and the captured images are processed in real time in order to detect the defect being sought, thereby differentiating it from others. In our system, we also carry out digital conversion of the image, which is not done in patent JP 631106265.

The applicant is unaware of the existence of any system that allows an automatic statistical inspection to be carried out on the surface of a metal sheet, for the purpose of detecting and classifying the existence of residual oxide on highly reflective metal surfaces, and which can be installed in a production line without stopping it.

### DESCRIPTION OF THE INVENTION

The device for detecting and classifying residual oxide in metal sheet production lines proposed by the invention satisfactorily solves the previously described problems in the different mentioned aspects, allowing the automatic detection of oxide stains around 50 um in size, by means of statistical sampling.

To this end, the invention consists of an optical system that incorporates at least one high-resolution camera, aided by strobe light sources and a light-diffusing screen, all of which are hermetically assembled in a box attached to a support carriage which is movable over the surface wherethrough the metal sheets pass in the production line, in addition to vertically. The movement of said carriage is controlled by a programmable automaton (PLC).

Therefore, the programmable automaton is in charge of moving the camera over a zone of the metal sheet surface to be examined which, given the nature of the oxide stains to be examined, which appear distributed with certain intensity, examination of 100% of the sheet is not required, a statistical sampling being sufficient, in such a manner that, thanks to the sheet movement speed and the synchronised sideways movement of the slide bar, a zig-zag sampling of the sheet surface is achieved, which is sufficient for determining the number of stains per unit area of surface.

The camera video signal is transferred to a PC via an image recording card, in such a manner that every image obtained is processed and the residual scale found is detected, quantified and classified in said PC, using aspecific programming software. Consequently, acquisition speed is not controlled by the video camera or line speed, but rather by the processing software, once it finishes processing the previous image.

Likewise, lighting intensity is not constant over time but rather is generated by strobe lights, as mentioned earlier, which are triggered by the end of processing of the preceding image.

Therefore, the system alerts us of the inadequacy of the surface stripping or cleaning system, according to the level of residual scale detected.

### DESCRIPTION OF THE DRAWINGS

For the purpose of complementing this description and helping to better understand the characteristics of the invention, in accordance with a preferred example of practical embodiment thereof, a set of drawings has been included as an integral part of this description, wherein the following figures have been represented in an illustrative but non-limiting manner:

FIG. 1.—Shows a perspective view of a device for detecting and classifying residual oxide in metal sheet production lines, manufactured in accordance with the object of the invention, where it appears duly installed in the production line.

FIG. 2.—Shows a profile view of the device in FIG. 1.

FIG. 3—Shows a perspective view of the box, wherein the optical and lighting elements that participate in the device of the invention are included.

FIG. 4.—Shows a profile view of the box in FIG. 3 without its sealing panels.

FIGS. 5 and 6.—Show respective perspective views of the slide bars for the horizontal and vertical movement of the box in FIGS. 3 and 4.

FIG. 7.—Finally shows a wiring diagram wherein the relationship between the different electronic components that participate in the device of the invention can be observed.

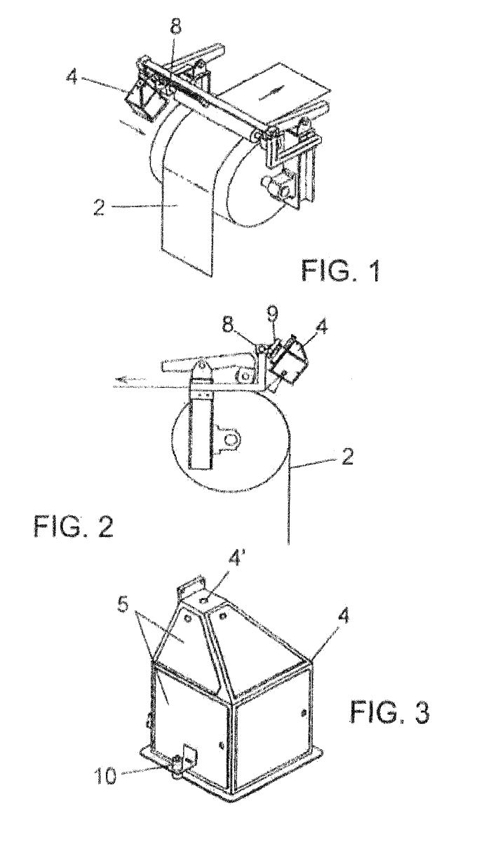

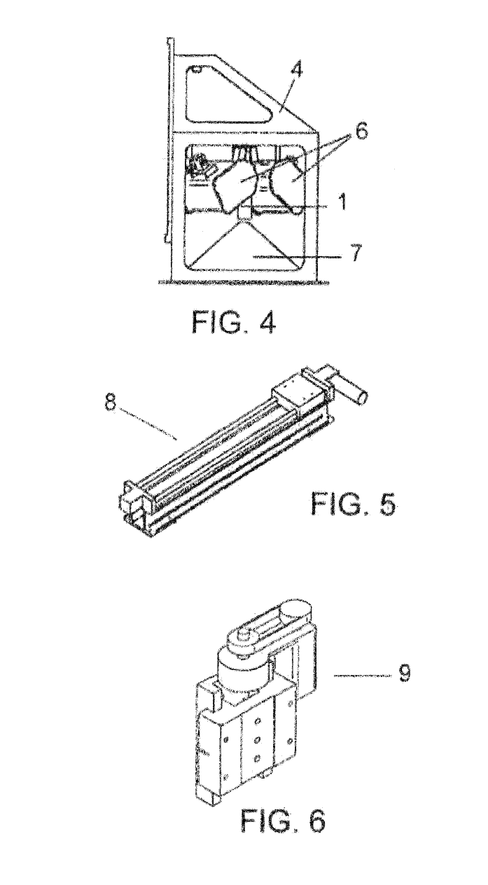

### PREFERRED EMBODIMENT OF THE INVENTION

In light of the foregoing figures, we can observe how a CCD camera (1), having a resolution in the plane of the object or steel sheet (2) of at least 40 pixels/mm, so that every pixel represents an object size of 25 um in such a manner that, using a programming software installed on a PC (3) related to said camera (1) as will be seen later in the text, it is capable of detecting stains having a minimum size of 50 um, i.e. that occupy at least 2×2 pixels, in order to ensure a sufficiently reliable detection algorithm, participates in the preconized device for detecting and classifying residual oxide in metal sheet production lines.

Said CCD camera (1) is arranged inside a box or framework (4), hermetically sealed, the interior of which can be accessed through practicable panels (5). In the chosen example of embodiment the box has a quadrangular prismatic configuration, the upper base of which extends along a truncated cone-shaped surface, although this configuration is merely illustrative, as said box may adopt different configurations without affecting the essentiality of the invention.

A pair of high-power strobe lights (6) are also arranged inside said box or framework (4), in addition to a diffusion surface (7) for diffusing the light generated by said lights (6), in order to avoid the formation of shades on the surface to be examined. A window wherein a glass is arranged wherethrough the camera (1) captures the images of the metal sheet (2) surface to be examined is established on the base of said framework (4).

Said box will preferably be hermetically sealed, as mentioned earlier, to prevent dust and dirt from entering it, and will have an exit (4′) for the cables of the different electrical and electronic elements included therein.

The framework or box (4) is fixed to a carriage (8), tshown in FIG. 5, equipped with a motor that allows it to move horizontally, sideways to the forward movement of the steel sheets (2), in addition to a carriage (9) capable of moving said box (4) in a vertical direction.

The sideways movement of the box (4), and therefore of the camera associated thereto, together with the movement in the advance direction of the steel sheets (2), allow the device to capture a sufficiently random sampling surface so as to ensure the high quality of the measurements made.

Optionally, if a larger sampling surface is desired, two or more boxes (4) may be arranged on each carriage (8).

Said carriage (9) is complemented by an ultrasound sensor (10) which allows the device to distinguish between different steel sheet thicknesses, in order to modify the vertical distance of the box (4) and therefore of the camera (1) with respect to the sheet surface to be examined, in such a manner that the camera is at the same distance from said surface at all times, and therefore at the same focal distance, avoiding the need for arranging self-focusing systems which, while being an equivalent solution that could be adopted, require a longer response time.

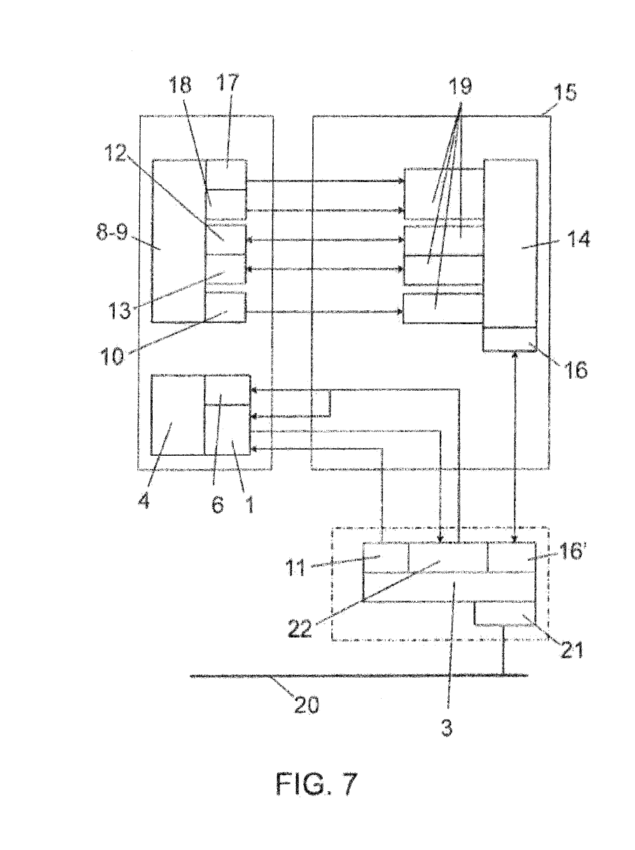

Therefore, as can be seen in FIG. 7, the camera (1) and strobe lights (6) are controlled through a PC (3), through an image recording card (22) and, optionally, through a serial port (11), while the horizontal and vertical movements of the carriages (8) and (9) by means of respective electric motors (12) and (13) are controlled by a programmable micro-controller or automaton (14) arranged in a control cabinet (15), related through the respective serial ports (16-16′), LAN or similar to said PC, and to the motors (12-13), end of path sensors (17), the ultrasound sensor (10) and anomaly or emergency sensors (18), through the corresponding entrances (19).

Therefore, every image is processed by applying different thresholding procedures and calculation of the statistics of the proportion of oxide stains found is based on the different sizes thereof within a certain band section of configurable length (typically between one and ten metres). This system does not require storage of all the images but only some (normally one) for every section for monitoring purposes and by way of example. The result of the system is the calculation of the proportion of oxide stains found based on different sizes in every longitudinal band section.

Finally, we must point out that the computer (3) may be connected to a local data network (20) through a LAN port (21) in order to transmit the processed information to other PCs.

Although the present description has been made based on the fact that the distancing between the camera (1) and the surface to be examined is carried out by moving the carriage (9) associated to the box (4), said carriage may optionally not be externally attached to the box (4) but rather internally, in such a manner that it only affects the vertical movement of said camera (1), maintaining the box (4) vertically immovable.

1. Device for detecting and classifying the residual oxide in metal sheet production lines comprising a high-resolution camera for the detection of residual oxide stains (residual scale) that (records) acquires and sends the images to a (controlling) PC processing unit where the images are obtained by means of strobe light, and a framework housing the camera, the framework equipped with means for sideways movement and a synchronized movement allowing a zig-zag sampling on the surface of the metal sheet to be examined for the purpose of obtaining as representative a sample as possible; a high-power lighting unit and diffuse light generator on the surface to be analysed, having envisaged that the movement of said framework is controlled by a programmable micro-controller or automaton with communication ports which allow association thereof to any processing device.

2. The device of claim 1, wherein the framework is fixed to a carriage that has a motor which allows horizontal movement, sideways to the advance movement of the metal sheets which allows a sufficiently representative sampling surface to be obtained.

3. The device of claim 1, wherein the framework comprises a carriage capable of moving said box vertically towards the working position.

4. The device of claim 1, wherein the camera has the means for vertical movement inside the framework or box electrically controlled by the programmable automaton and regulated by an ultrasound sensor arranged in said framework, which is configured to detect the distance between the framework and the surface to be inspected.

5. The device of claim 1, wherein said means for sideways movement of the framework is in a horizontal slide bar assembly that has a carriage wherein an electric motor is arranged for controlling the movement thereof.

6. The device of claim 1, wherein two or more frameworks with their corresponding inner elements, may optionally be arranged on the carriage of said means for horizontal movement.

7. The device of claim 1, wherein the lighting system is materialised in a pair of strobe lights and a light diffuser.

8. The device of claim 1, wherein the framework is hermetically sealed by means of practicable panels, in order to prevent dust from entering therein, and having a window arranged on the lower base thereof equipped with a glass to which the camera lens is opposed.
